(19) United States
(12) Patent Application Publication
(10) Pub. No.: US 2016/0335655 A1
(43) Pub. Date: Nov. 17, 2016

(54) RULE-DIRECTED COUPON GENERATION BASED ON SCORING THE OVER-REDEMPTION OF COUPONS BY CONSUMERS

(71) Applicant: OnCard Marketing, Inc., New York, NY (US)

(72) Inventors: Gregory Hansen, Township of Washington, NJ (US); Randall Malluk, Franklin Lakes, NJ (US); Stephanie Martone, New York, NY (US)

(21) Appl. No.: 14/709,461

(22) Filed: May 11, 2015

(51) Int. Cl. G06Q 30/02

(52) U.S. Cl. CPC G06Q 30/0225; G06Q 30/0224; G06Q 30/0233

(57) ABSTRACT

Coupon and consumer identifiers are encoded directly or indirectly into coupon barcodes, and upon redemption of coupons, the coupon and consumer identifiers are used to identify fraudulent duplicate redemptions of coupons by consumers. Scores are created based on consumer redemption histories and used to represent a consumer's past history for over-redeeming electronic coupons (redeeming a coupon more than an authorized or allowed number of times). When a consumer is subsequently presented with an opportunity to receive another electronic coupon offer, the consumer's score can be checked in real-time in advance, and the offer can be tailored, adjusted, or even not presented at all to account for the consumer's past propensity to over-redeem coupons. A consumer's score can be checked in real-time upon presentation of a coupon and the coupon can be accepted or rejected based on the score.

### RELATED APPLICATIONS

The subject matter of this application is related to U.S. patent application Ser. No. 13/028,514 entitled, “A System and Method for Delivering a Geographically Restricted In-Store Promotion to a Consumer” filed Feb 16, 2011, U.S. patent application Ser. No. 13/008,389 entitled, “A System and Method for Delivering a Restricted Use In-Store Promotion to a Consumer” filed Jan. 18, 2011, U.S. patent application Ser. No. 13/007,824 entitled, “A System and Method for Delivering an Authorized In-Store Promotion to a Consumer” filed Jan. 17, 2011, and U.S. patent application Ser. No. 12/958,984, entitled, “A System and Method for Delivering an In-Store Promotion to a Consumer” filed Dec. 2, 2010, the entire contents of all of which applications are hereby incorporated by reference in their entireties.

### SUMMARY

Generally, an electronic coupon is provided to a consumer with the understanding or expectation that the coupon will only be printed and/or used once. Consumers, however, can and often do redeem electronic coupons more than just once, which creates financial risk and liability for brands that offer coupons. For example, a consumer can photocopy a printed coupon or be shown a printable electronic coupon in a web browser, print multiple copies of the coupon, and then fraudulently redeem the coupon multiple copies. In accordance with one embodiment, coupon and consumer identifiers are encoded directly or indirectly into coupon barcodes and upon redemption of coupons, the coupon and consumer identifiers are used to identify fraudulent duplicate redemptions of coupons by consumers.

Scores are created based on consumer redemption histories and used to represent a consumer's past history for over-redeeming electronic coupons (redeeming a coupon more than an authorized or allowed number of times). When a consumer is subsequently presented with an opportunity to receive another electronic coupon offer, the consumer's score can be checked in real-time in advance, and the offer can be tailored, adjusted, or even not presented at all to account for the consumer's past propensity to over-redeem coupons. A consumer's score can be checked in real-time upon presentation of a coupon and the coupon can be accepted or rejected based on the score.

### BRIEF DESCRIPTION OF THE DRAWINGS

FIG. 1A illustrates a system 100 for providing printable electronic coupons based on scores and tracking consumer's redemptions in accordance with one embodiment.

FIG. 1B illustrates a coupon generation system 120 and a consumer profiling system 140 in accordance with one embodiment.

FIG. 2 is a block diagram of a general purpose computer with computer programs providing instructions to be executed by a processor in the general purpose computer.

### DETAILED DESCRIPTION

In the following description, reference is made to the accompanying drawings, which form a part hereof, and which show, by way of illustration, specific embodiments or processes in which the invention may be practiced. Where possible, the same reference numbers are used throughout the drawings to refer to the same or like components. In some instances, numerous specific details are set forth in order to provide a thorough understanding of the present invention. The present invention, however, may be practiced without the specific details or with certain alternative equivalent devices, components, and methods to those described herein. In other instances, well-known devices, components, and methods have not been described in detail so as not to unnecessarily obscure aspects of the present invention.

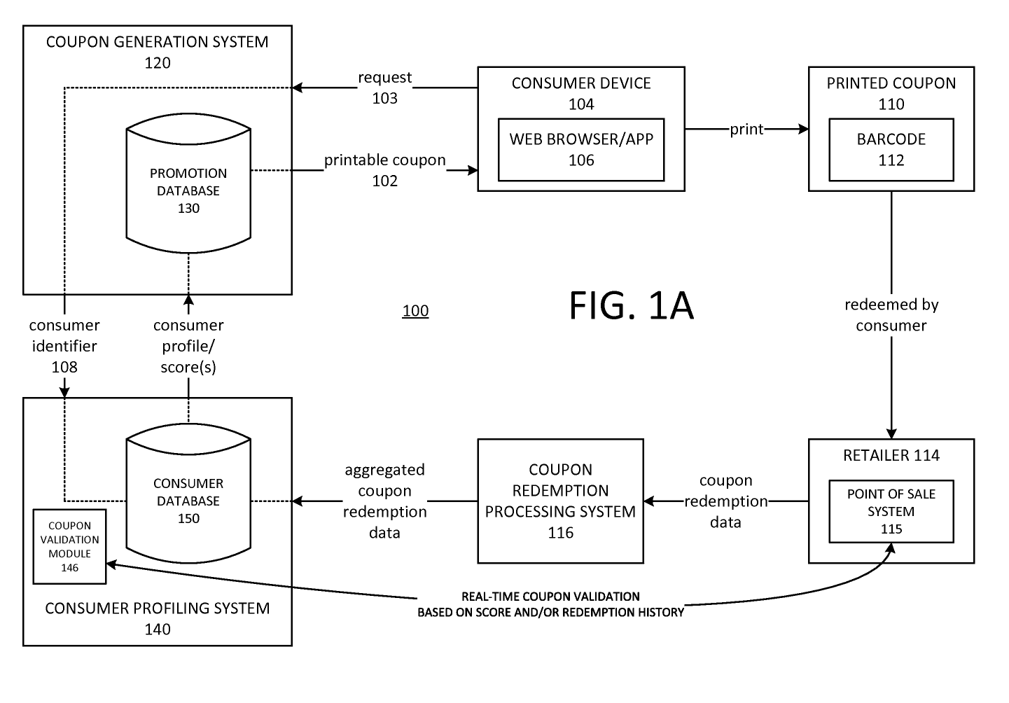

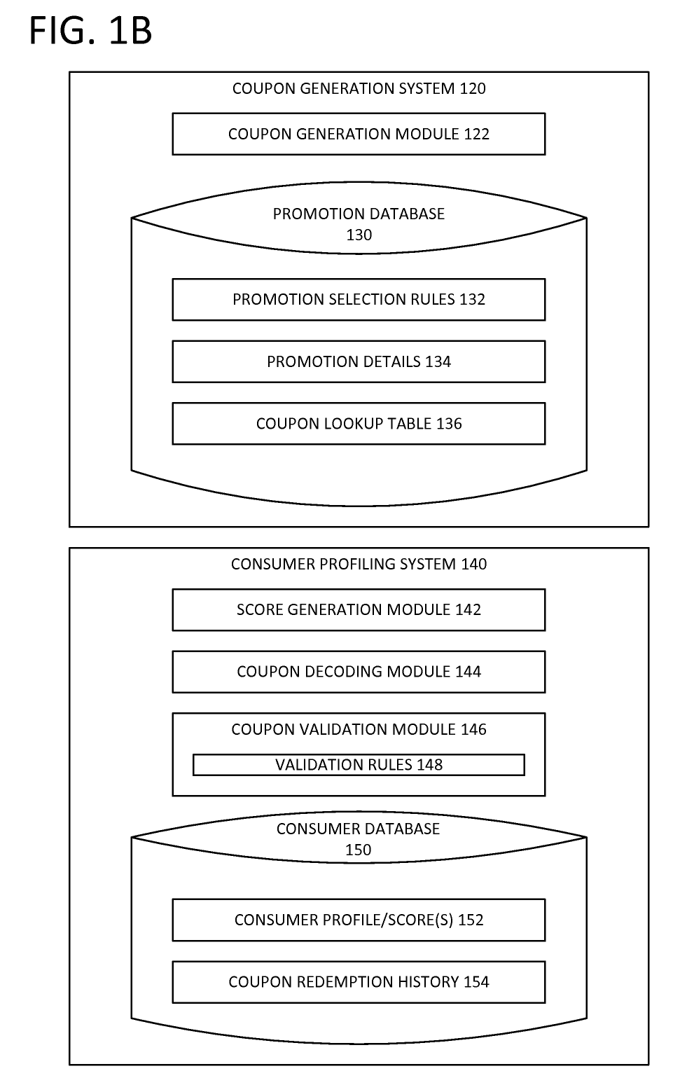

FIG. 1A illustrates a system 100 for providing printable electronic coupons based on scores and tracking consumer's redemptions in accordance with one embodiment.

FIG. 1B illustrates a coupon generation system 120 and a consumer profiling system 140 in accordance with one embodiment.

Referring to FIGS. 1A and 1B, a consumer uses a consumer device 104 to access a printable electronic coupon 102 from a coupon generation system 120. The printable electronic coupon 102 can be, for example, an image or data file. In accordance with one embodiment, the coupon or a version of it can be displayable on a display of the consumer device 104. In accordance with one embodiment, the displayed coupon or a version of it can be printed on a printer accessible from the consumer device 104 to create a printed coupon 110. The consumer device 104 can be, for example a desktop computer, a tablet, a mobile device or any device capable of accessing the printable electronic coupon, and the consumer device 104 can be configured to execute a web browser or app 106 through which the printable coupon 102 can be retrieved, displayed and printed. Additional variations on devices and processes that can be used are set forth in the applications referenced in the RELATED APPLICATIONS section above.

The printable coupon 102 is configured such that the resulting printed coupon 110 includes a barcode or other machine-readable indicia. In addition to or instead of the barcode 112, the printed coupon can include an identifying number or human-readable code that can be keyed in by a cashier, for example, in case the barcode is not readable or that a consumer can provide, for example, to an on-line web-based checkout system. As used herein, the term barcode shall be understood to include the barcode itself, other machine-readable indicia or a sequence of characters that can be keyed in by a cashier or provided by a consumer in lieu of a barcode.

The barcode includes encoded data that can be encoded algorithmically, such as using an encoding process, using hash or lookup tables, or using a combination of algorithmic processes and lookup tables. The data encoded in the barcode can specify information about a promotion to which the coupon applies, such as applicable product(s), service(s), discount(s) and/or a promotion identifier that can be used to look up properties of the promotion from an on-line server upon redemption. The encoded data can be encoded directly in the barcode, the encoded data can be stored in a database where a reference that can be used to look up the stored data can be encoded into the barcode to access the encoded data or a combination of encoding into the barcode and encoding by database look ups can be used. Additional variations on data that can be encoded in the barcode and methods for encoding the data are set forth in the applications referenced in the RELATED APPLICATIONS section above. As used herein, encoded data should be understood to include data that is encoded directly into a code (e.g. using an algorithmic process), data that is encoded indirectly into the code, such as data stored in a database where a reference to the stored data is encoded directly into the code or a portion of the code, or data that is encoded into a code using a combination of direct and indirect encoding.

In accordance with one embodiment, the encoded data can include a consumer identifier 108 that can be used to uniquely distinguish the consumer receiving the coupon from other consumers. The consumer identifier 108 can be, for example, a unique identifier that has been associated with the consumer and used to identify the consumer when the consumer requests printable coupons. The consumer identifier may or may not be associated with a consumer's personally identifiable information, such as their name, address, e-mail, or telephone number. A consumer identifier 108 can be, for example, a globally unique identifier or any other identifier that can be used to distinguish the consumer from other consumers. In accordance with one embodiment, registration by the consumer for the coupon or download of any software in order to obtain the coupon is not required for an identifier to be assigned.

In accordance with one embodiment, the encoded data can be made unique so as to uniquely identify the printable coupon instance to distinguish the printable coupon instance from other printable coupon instances, possibly offering the same discount, deal or promotion, that have been accessed by the same consumer or other consumers. For example, the encoded data can include a time and/or date stamp, or a unique coupon identifier, such as different globally unique identifier for each printable coupon instance. In one embodiment, the barcode itself can be a unique identifier, e.g. a unique coupon identifier, that can be used to uniquely identify the printable coupon instance. In one embodiment, the encoded data for a printable coupon instance is maintained and kept consistent between multiple coupon requests for the same promotion associated with a single consumer identifier 108. In this manner, multiple requests associated with the same consumer identifier 108 can be configured to produce identical printable coupon instances.

In accordance with certain embodiments, the system 100 can be configured to create and track the redemption of other kinds of coupons than printable electronic coupons 102. The additional kinds of coupons can include, for example, mobile coupons, such as can be displayed on the screen of a mobile device and coupons which a saved to a card or other electronic account. In the case of a mobile coupon, the system 100 can work in a similar manner, but without the need for the coupon to be printed by instead instructing the consumer to scan the coupon as displayed on the mobile device upon checkout. In general the system 100 can be configured to work with any format of coupon that can be displayed by a consumer device 104 and scanned by a retailer. The additional kinds of coupons can also include, for example, e-commerce coupon codes, which can be displayed to a consumer on the consumer device 104 and then entered by the consumer when shopping at or checking out from an e-commerce web site. In the case of an e-commerce coupon, a consumer identifier 108 can be encoded into the coupon code or alternative means for tracking the use of the coupon can be implemented, such as using a web browser cookie or a public IP address.

Referring to FIG. 1A, the consumer device 104 initiates a request 103 for a coupon 102 from the coupon generation system 120. The request 103 can be, for example, an http request generated by a web browser 106 based on a link or URL accessed directly or indirectly by the consumer. The link that leads to the request can be, for example, a link on a web page, such as a selectable digital advertisement, a link embedded within an image, a link within an e-mail, a link within an application or app executing on a mobile device, or any other hypertext link or URL, such as on a brand website, an affiliate website or a mobile website. The request can but need not include promotion identification data, such as a promotion identifier, referencing a promotion campaign that may have been displayed to the consumer and selected by the consumer to generate the request. Additional variations on how consumers can request coupons are set forth in the applications referenced in the RELATED APPLICATIONS section above.

In accordance with one embodiment, the request 103 includes profiling data based upon which the coupon generation system 120 can identify the consumer by way of a consumer identifier 108. The consumer identifier 108 can be any identifying data that can be received in association with or derived from a request 103 and can be used to associate multiple requests for coupons coming from the same consumer or from the same consumer device 103.

In one embodiment, the profiling data does not include the consumer identifier 108, but can include data based upon which the coupon generation system 120 can identify the consumer identifier 108, such as, for example, one or more of a public IP address of the consumer device, a unique device identifier (e.g. a combination of one or more of MAC address, processor ID, operating system version, etc.), or a user name supplied by an affiliate or client. The profiling data can be or include, for example, a token that may have been previously stored on the web browser 106 using a web browser cookie in response to a previous coupon request. If a request is received from a consumer, device, or IP address, for example, from which no prior requests have been received, the coupon generation system 120 can create a new identifier in response to the request and associate the identifier with the consumer, device or IP address.

Alternatively, the profiling data can include the consumer identifier 108 or one or more elements of the profiling data can be used or combined to form the consumer identifier 108. It will be appreciated that the use of certain identifiers as consumer identifiers, such as an IP address, may not be perfect identifiers to distinguish consumers, since multiple consumers, such as a husband and wife, might share a single public IP address, but in such instances, the two consumers can effectively be considered a single consumer from the system's perspective.

In response to receiving the request 103 and identifying the consumer identifier 108, the coupon generation system 120 uses the consumer identifier 108 to access a profile 152 (FIG. 1B) for the requesting consumer from a consumer database 150 maintained by a consumer profiling system 140. The profile 152 includes one or more scores based upon which the coupon generation system can select a coupon or offer for the consumer. In accordance with one embodiment, the scores for all consumers are normalized to a common scale, such as, for example, a scale of 0 to 100, where higher scores are indicative of a consumer with higher numbers of past over-redemptions of coupons.

In one embodiment, the coupon generation system 120 includes a coupon generation module 122 that creates electronic coupons 102 in real-time, on demand, based on the request 103, the profile 152, and data retrieved from a promotion database 130. The promotion database 130 can include promotion selection rules 132 that the coupon generation module 122 can apply to a consumer profile 152 for a specific request in order to identify a specific promotion.

In accordance with one embodiment, the system 100 can support multiple promotion campaigns, where each promotion campaign has an associated set of promotion selection rules 132. A particular promotion campaign can be made available to consumers by publishing or distributing to consumers selectable links that include an identifier of the campaign. Selection of a link associated with the campaign will generate an incoming request 103 that identifies the campaign. The coupon generation module 122 can then identify the associated set of promotion selection rules 132 by examining the request 103.

In accordance with one embodiment, a set of promotion selection rules 132 can be configured to match each of multiple ranges of scores within a range of scores to a particular promotion. For example, a set of four rules can be configured to associate scores within a normalized range of 0 to 100 to particular promotions as follows:

0≦score<25: promotion 1 (25% off)

25≦score<50: promotion 2 (15% off)

50≦score<75: promotion 3 (10% off)

75≦score≦100: promotion 4 (5% off)

For a particular set of rules (e.g. associated with a promotion campaign), different promotions associated with different rules can be configured to vary, for example, the promotion value (e.g. amount or discount), the promotion content (e.g. text, images, or creative content), the promotion eligibility (e.g. no coupon offered at all), the promotion or coupon expiration, the redemption method (e.g. paper, mobile, or e-commerce coupon code), the promotion terms and conditions, and the number of times a coupon can be legitimately used or redeemed. For example, a rule can be created for a score range, such as 95≦score≦100, to provide no promotion to certain consumers who have a history of many over-redemptions. In the case that no promotion is selected for a consumer, the consumer can be shown, for example, instead of a printable coupon, a non-coupon advertisement or educational material explaining legitimate and illegitimate uses of printable electronic coupons. In the case a new consumer is encountered, the new consumer can be assigned a default score, such as 0, or a rule can be created to handle the case where a new consumer has no score.

In accordance with one embodiment, promotion rules can be configured to match on or account for properties in addition to a consumer's score, such as a consumer's geographic location, age, or IP address. Rules can be configured to match on or account for more than just a single kind of score. For example, one score can account for a consumer's propensity to over-redeem a brand's coupons, while another score can account for a consumer's propensity to redeem coupons in general. In accordance with one embodiment, scores representing different consumer behaviors, such as a propensity to over-redeem and a propensity to redeem in general, can be combined into a single score, such as, by weighting the different scores in a single combined score. In one embodiment, some rules can be configured to account for a consumer's over-redemption score, while other rules might not take the over-redemption score into account.

Once a specific promotion is identified, the coupon generation module 122 can create the electronic coupon 102 based on promotion details 134 that can also be stored in the promotion database 130. The promotion details 134 can include, for example, creative content, such as images or text, based upon which to create the coupon. The promotion details 134 can also include, for example, terms of a promotion, such as identifications of qualifying purchases, an amount of discount and a coupon expiration data. In one embodiment, the coupon generation module 122 encodes the promotion terms into the barcode for the printable electronic coupon in conjunction with a unique coupon identifier, a consumer identifier or both.

In one embodiment, the coupon generation module 122 creates the barcode by encoding into the barcode directly and/or indirectly one or more fields of data to be represented by the barcode. Each field of data can, for example, be associated with an identifier where the field and identifier are stored and associated in a coupon lookup table 136. Multiple fields of data can be represented in a barcode by algorithmically encoding multiple identifiers into the barcode. Alternatively, one or more of the fields of data can be encoded into the barcode directly or algorithmically without the need of a lookup table 136. When the barcode is decoded, the identifiers and/or fields of data can be algorithmically extracted from the barcode, a lookup performed using the coupon lookup table 136 for any field represented by an identifier, and/or a combination of algorithmic decoding and lookup can be used to decode directly and/or indirectly encoded data. The encoded data that can be associated by lookup table entries can include, for example, the consumer identifier 108, the identification of the promotion, and/or other information about the coupon that might not be directly encoded in the coupon barcode. The coupon lookup table 136 can be maintained in the promotion database 130, the consumer database 150, or both.

In one embodiment, the coupon generation module 122 can encode a unique coupon identifier or serial number into the barcode. In one embodiment, the encoded barcode data itself is used as a unique coupon identifier. Alternatively, only a portion of the encoded barcode data is used to represent the unique coupon identifier or serial number. The unique coupon identifier can be inserted into the barcode in clear text or it can be directly or indirectly encoded into the barcode. When decoding the encoded barcode data, the unique coupon identifier can be used in conjunction with one or more other fields in the barcode and/or lookup tables to algorithmically obtain an indirectly encoded consumer identifier 108.

When a consumer redeems a coupon at a retailer 114, the retailer scans the barcode, identifies and applies the terms of the promotion, and transmits coupon redemption data, such as barcode data, decoded or extracted unique coupon identifiers, or other coupon redemption information, to a coupon redemption processing system 116. The coupon redemption processing system 116 aggregates coupon redemption data, possibly from multiple retailers 114 and multiple customers, into batch files that are then transmitted back to the consumer profiling system 140. The coupon redemption processing system 116 can be operated by a retailer, a coupon clearing house, or another type of organization or entity. In one embodiment, the coupon redemption processing system 116 is bypassed and coupon redemption data are passed directly from the retailer to the consumer profiling system.

When the consumer profiling system 140 receives the coupon redemption data, a coupon decoding module 144 decodes the received coupon redemption data to obtain data about redeemed coupons such as, for example, the unique coupon identifier, the consumer identifier 108, the promotion identifier, and the terms of the promotion. In one embodiment, the data is obtained by dereferencing the received coupon redemption data using the coupon lookup table 136, which can be configured to store the data upon creation of the coupon. In one embodiment, the coupon decoding module 144 can algorithmically decode received encoded barcode data and/or coupon redemption data in order to obtain the coupon information. In one embodiment, a combination between algorithmic decoding and lookups can be used.

In accordance with one embodiment, the consumer profiling system 140 logs received coupon redemption data, decoded coupon redemption data, or both into a coupon redemption history 154. The coupon redemption history 154 can be a database or part of a database, such as the consumer database 150, configured to maintain an ongoing log of redeemed coupons. The coupon redemption history 154 can be indexed on one or more of, for example, received coupon redemption data, unique coupon identifier, and consumer identifier. The log can be maintained indefinitely or alternatively, the log can be configured as a rolling log such that entries are removed or roll off after a period of time elapses post the time or date of redemption. In one embodiment, the coupon redemption history 154 can be configured to log, for each redemption, some or all of the data decoded from received coupon redemption data, which can include, for example, one or more of the coupon identifier, the consumer identifier, the promotion identifier, and the terms of the promotion. The coupon redemption history 154 can also be configured to log, for example, a time and/or time/date of redemption.

The consumer profiling system 140 can include a score generation module 142, which processes consumer redemption histories 154 in order to create scores that are stored in consumer profiles 152. In one embodiment, the score generation module 142 regenerates or recalculates the scores in real-time or on a periodic basis, such as daily, weekly or monthly, to account for new, updated, or refreshed data in the coupon redemption history 154. In one embodiment, the score generation module 154 rolls off data in the coupon redemption history 154 by ignoring data regarding redemptions that are more than a specified age.

In one embodiment, the score generation module 142 creates scores that represent consumers' past history of redeeming coupons more than an authorized number of times. These scores, in turn, can be used by the coupon generation module 122 in conjunction with the promotion selection rules 132 to select appropriate promotions based on a consumer's past history of over-redeeming printed coupons. One or more scores representative of a consumer's propensity to over-redeem can be created using different methods.

In accordance with one embodiment, the score generation module 142 is configured to create a score representative of a consumer's propensity to over-redeem by starting with a determination of a consumer's number of over-redemptions across all coupons redeemed. The number of redemptions for a coupon can be determined by querying, for example, for multiple instances of the same unique coupon identifier or a combination between unique coupon identifier and consumer identifier in the coupon redemption history 154, where each redemption may have a different time of redemption.

The number of over-redemptions for each coupon redeemed can be determined by subtracting the number of authorized redemptions for the coupon from the number of redemptions logged in the coupon redemption history 154. Typically the number of authorized redemptions for a coupon will be two, which can be used as a default, but promotions can be specifically tailored to allow one, three, or more redemptions of a printable coupon instance. The numbers of over-redemptions for all coupons redeemed by the consumer can be summed to obtain the consumer's number of over-redemptions across all coupons redeemed. In one embodiment, this raw score of the actual number of over-redeemed coupons can be used by the coupon generation module 122 and rules can be created to account for this raw score. Raw scores that are not normalized (e.g. where there is no upper limit on the range of scores) can be handled by including a rule that triggers on all scores above a certain number or by creating a default rule that handles all scores that are not otherwise specifically accounted for by other rules. For example, a rule could specify that for any number of over-redemptions above 25, the consumer should receive no promotion whatsoever.

In accordance with one embodiment, a range of scores, such as the number of over-redemptions across all coupons redeemed, can be scaled, compressed or smoothed. In one embodiment, for example, the score for each consumer can be calculated by taking the logarithm of the raw score. By taking the logarithm, raw scores that range over several orders of magnitude can be adjusted so that rules need not account for variations in scores of several orders of magnitude.

In accordance with one embodiment, raw, scaled, compressed, or smoothed scores can be normalized to create scores that will be limited to a predefined range of values. The normalization can be performed, for example, by dividing all scores of consumers by the maximum of all the scores, then optionally scaling by a multiplier, such as 100 to produce a range of 0 to 100. By normalizing the scores, rules can be created with more predictability with respect to their applicability over different possible ranges of raw scores.

In accordance with one embodiment, the raw number of over-redemptions across all coupons redeemed for all consumers are processed to create a percentile ranking of each consumer's score. This percentile ranking can be used similarly and provides similar benefits to a scaled score and rules can be created accordingly. The percentile ranking can be created using known techniques.

In accordance with certain embodiments, multiple over-redemption scores can be determined separately. For example, different over-redemption scores can be determined for different product classes, services, or different retailers. Different over-redemption scores can also be determined for different time periods. Multiple over-redemption scores can be weighted and combined to achieve desired objectives.

Referring again to FIGS. 1A and 1B, in accordance with one embodiment, a coupon validation module 146 can be configured to provide a coupon validation service that allows retailers to reject coupons at a point of sale 115. Point of sale systems 115 at retailers 114 can be configured to transmit coupon redemption and/or barcode information over a real-time communication link to the coupon validation module 146. The coupon validation module 146, in turn, can make rule-based determinations on whether the coupon being presented at the retailer should be accepted based on a consumer's over-redemption score. In one embodiment, the coupon validation module 146 stores a set of over-redemption-based validation rules 148 based upon which it makes determinations. If an applicable rule determines that a coupon should or should not be accepted, then a real-time response can be sent from the coupon validation module 146 back to the point of sale system 115. The point of sale system 115 can then accept or reject the coupon in accordance with the response.

The coupon generation system 120, the consumer profiling system 140, the consumer device 104, and the coupon redemption processing system 116 can each be instantiated using one or more general purpose computers. The promotion database 130 and the consumer database 150 can be implemented using a single database or they can each be implemented using one or more separate databases as needed. A generic description of a general purpose computer, including features and functionality that may or may not be needed for each of the coupon generation system 120, the consumer profiling system 140, the consumer device 104, and the coupon redemption processing system 116 is described below.

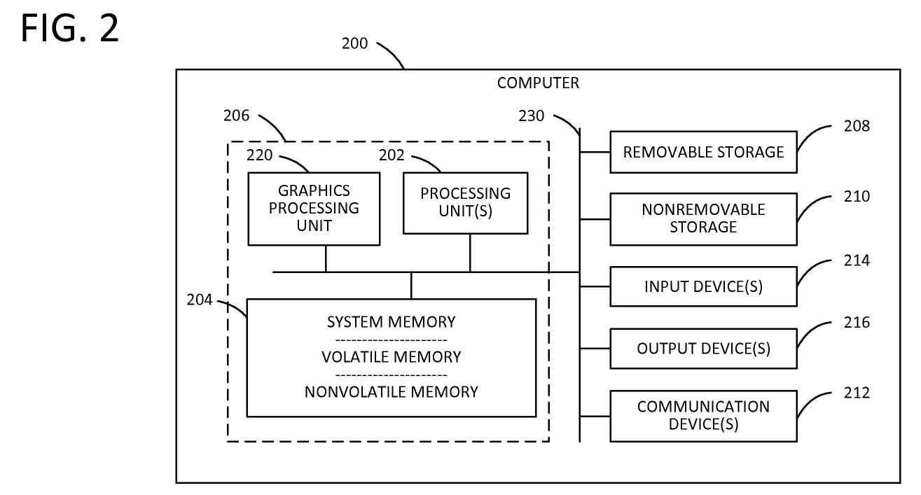

FIG. 2 is a block diagram of a general purpose computer with computer programs providing instructions to be executed by a processor in the general purpose computer. Computer programs on a general purpose computer generally include an operating system and applications. The operating system is a computer program running on the computer that manages access to various resources of the computer by the applications and the operating system. The various resources generally include memory, storage, communication interfaces, input devices and output devices.

Examples of such general purpose computers include, but are not limited to, larger computer systems such as server computers, database computers, desktop computers, laptop and notebook computers, as well as mobile or handheld computing devices, such as a tablet computer, hand held computer, smart phone, media player, personal data assistant, audio and/or video recorder, or wearable computing device.

With reference to FIG. 2, an example computer 200 includes at least one processing unit 202 and memory 204. The computer can have multiple processing units 202 and multiple devices implementing the memory 204. A processing unit 202 can include one or more processing cores (not shown) that operate independently of each other. Additional co-processing units, such as graphics processing unit 220, also can be present in the computer. The memory 204 may include volatile devices (such as dynamic random access memory (DRAM) or other random access memory device), and non-volatile devices (such as a read-only memory, flash memory, and the like) or some combination of the two. This configuration of memory is illustrated in FIG. 2 by dashed line 206. The computer 200 may include additional storage (removable and/or non-removable) including, but not limited to, magnetically-recorded or optically-recorded disks or tape. Such additional storage is illustrated in FIG. 2 by removable storage 208 and non-removable storage 210. The various components in FIG. 2 are generally interconnected by an interconnection mechanism, such as one or more buses 230.

A computer storage medium is any medium in which data can be stored in and retrieved from addressable physical storage locations by the computer. Computer storage media includes volatile and nonvolatile memory devices, and removable and non-removable storage media. Memory 204 and 206, removable storage 208 and non-removable storage 210 are all examples of computer storage media. Some examples of computer storage media are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. Computer storage media and communication media are mutually exclusive categories of media.

The computer 200 may also include communication device(s) 212 through which the computer communicates with other devices over a communication medium such as a computer network. Communication media typically transmit computer program instructions, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media include any non-wired communication media that allows propagation of signals, such as acoustic, electromagnetic, electrical, optical, infrared, radio frequency and other signals.

Communications device(s) 212 can include, for example, a network interface or radio transmitter, that interface with the communication media to transmit data over and receive data from signals propagated through communication media. The communication device(s) 212 can include one or more radio transmitters for telephonic communications over cellular telephone networks, and/or wireless connections to a computer network. For example, a cellular connection, a WiFi connection, a Bluetooth connection, and other connections may be present in the computer. Such connections support communication with other devices, such as to support voice or data communications.

The computer 200 may have various input device(s) 214 such as a various pointer (whether single pointer or multipointer) devices, such as a mouse, tablet and pen, touchpad and other touch-based input devices, image input devices, such as still and motion cameras, audio input devices, such as a microphone, and various sensors, such as accelerometers, thermometers and the like, and so on. Output device(s) 216 such as a display, speakers, printers, and so on, also may be included. All of these devices are well known in the art and need not be discussed at length here.

The various storage 210, communication device(s) 212, output devices 216 and input devices 214 can be integrated within a housing of the computer, or can be connected through various input/output interface devices on the computer, in which case the reference numbers 210, 212, 214 and 216 can indicate either the interface for connection to a device or the device itself as the case may be.

An operating system of the computer typically includes computer programs, commonly called drivers, that manage access to the various storage 210, communication device(s) 212, output devices 216 and input devices 214. Such access generally includes managing inputs from and outputs to these devices. In the case of communication device(s), the operating system also may include one or more computer programs for implementing communication protocols used to communicate information between computers and devices through the communication device(s) 212.

Any of the foregoing aspects may be embodied in one or more instances as a computer system, as a process performed by such a computer system, as any individual component of such a computer system, or as an article of manufacture including computer storage in which computer program instructions are stored and which, when processed by one or more computers, configure the one or more computers to provide such a computer system or any individual component of such a computer system. A server, computer server, a host or a client device can each be embodied as a computer or a computer system. A system or computer system can include multiple computers or multiple computer systems connected by a computer network.

Each component (which also may be called a “module” or “engine” or the like), of a computer system such as described herein, and which operates on one or more computers, can be implemented using the one or more processing units of the computer and one or more computer programs processed by the one or more processing units. A computer program includes computer-executable instructions and/or computer-interpreted instructions, such as program modules, which instructions are processed by one or more processing units in the computer. Generally, such instructions define routines, programs, objects, components, data structures, and so on, that, when processed by a processing unit, instruct the processing unit to perform operations on data or configure the processor or computer to implement various components or data structures.

Although the invention has been described in terms of certain embodiments, other embodiments that will be apparent to those of ordinary skill in the art, including embodiments which do not provide all of the features and advantages set forth herein, are also within the scope of this invention. Accordingly, the scope of the invention is defined by the claims that follow. It should be understood that the subject matter defined in the appended claims is not necessarily limited to the specific implementations described above. The specific implementations described above are disclosed as examples only. In the claims, the term “based on” shall include situations in which a factor is taken into account directly and/or indirectly, and possibly in conjunction with other factors, in producing a result or effect. In the claims, a portion shall include greater than none and up to the whole of a thing; encryption of a thing shall include encryption of a portion of the thing.

What is claimed is:

1. A system comprising:
a consumer profiling system configured to create and maintain coupon over-redemption scores for consumers based on received coupon redemption data, wherein the consumer profiling system comprises:
a coupon decoding module configured to obtain decoded coupon redemption data for a redeemed coupon by decoding received coupon redemption data, wherein the decoded coupon redemption data comprise a unique consumer identifier and a unique coupon identifier,
a consumer database configured to store:
a coupon redemption history comprising unique consumer identifiers stored in association with unique coupon identifiers, the coupon redemption history based on decoded coupon redemption data obtained from the coupon decoding module, and
unique consumer identifiers in association with coupon over-redemption scores, and
an over-redemption score generation module configured to calculate a coupon over-redemption score based on the coupon redemption history, wherein the coupon over-redemption score is indicative of a consumer's history of having redeemed unique coupons more than an allowed number of times; and
a coupon generation system configured to provide electronic coupons in response to requests from consumer devices, the coupon generation system comprising:
a promotion database, the promotion database configured to store:
promotion details for a plurality of promotions, and
a plurality of over-redemption-based promotion selection rules, wherein each of the plurality of rules is configured to select among the plurality of promotions based at least on an over-redemption score, and
a coupon generation module configured to:
access a consumer identifier in response to a received request for an electronic coupon,
access the consumer database to obtain an over-redemption score based on the accessed consumer identifier,
match a rule selected from the plurality of rules based on the obtained over-redemption score,
select a promotion based on the matched rule, and
encode a plurality of fields of data for inclusion in an electronic coupon for the selected promotion, wherein the plurality of fields of data comprise the unique consumer identifier and the unique coupon identifier.

2. The system of claim 1,
wherein the coupon generation module is configured to indirectly encode at least one of the plurality of fields for inclusion in the electronic coupon by, for each of the at least one of the plurality of fields of data:
associating the field of data with an identifier,
storing the field of data in a database in association with the identifier, and
encoding the identifier directly into the electronic coupon; and
wherein the coupon decoding module is configured to obtain decoded coupon redemption data for a redeemed coupon by, for each of at least one of a plurality of indirectly encoded fields of data:
decoding an identifier from the coupon redemption data, and
using the decoded identifier to look up an indirectly encoded field of data in a database.

3. The system of claim 1, wherein the over-redemption score generation module is configured to calculate the coupon over-redemption score for a consumer by:
determining, for each of a plurality of coupons redeemed by the consumer in the coupon redemption history, a number of over-redemptions above an allowed number of redemptions for the coupon; and
summing the number of over-redemptions across the plurality of coupons.

4. The system of claim 3, wherein the over-redemption score generation module is configured to calculate the coupon over-redemption score for a consumer by further:
applying a logarithm to the summed number of over-redemptions across the plurality of coupons for a consumer to obtain a compressed score; and
normalizing the compressed score by scaling the compressed score in relation to a range of compressed scores for a plurality of consumers.

5. The system of claim 3, wherein the over-redemption score generation module is configured to calculate a coupon over-redemption score for a plurality of consumers by further assigning a percentile rank to each consumer in relation to others of the plurality of consumers based on a summed number of over-redemptions across a plurality of coupons for the consumer.

6. The system of claim 1, wherein the electronic coupons include coupons that are configured to be printed or displayed by the consumer devices, and for which coupons the coupon generation module encodes the plurality of fields of data into a barcode displayable on the coupon.

7. The system of claim 1, wherein the electronic coupons include coupons that are configured to include a human-readable code that can be entered or supplied by a consumer during an on-line or off-line purchase, and for which coupons the coupon generation module encodes the plurality of fields of data into the human-readable code.

8. A consumer profiling system configured to create and maintain coupon over-redemption scores for consumers based on received coupon redemption data, wherein the consumer profiling system comprises:
a coupon decoding module configured to obtain decoded coupon redemption data for a redeemed coupon by decoding received coupon redemption data, wherein the decoded coupon redemption data comprise a unique consumer identifier and a unique coupon identifier;
a consumer database configured to store:
a coupon redemption history comprising unique consumer identifiers stored in association with unique coupon identifiers, the coupon redemption history based on decoded coupon redemption data obtained from the coupon decoding module, and
unique consumer identifiers in association with coupon over-redemption scores; and
an over-redemption score generation module configured to calculate a coupon over-redemption score based on the coupon redemption history, wherein the coupon over-redemption score is indicative of a consumer's history of having redeemed unique coupons more than an allowed number of times, and
wherein the consumer profiling system is further configured to provide the coupon over-redemption scores in response to requests from a coupon generation system configured to provide electronic coupons in response to requests from consumer devices, wherein the coupon generation system comprises:
a promotion database, the promotion database configured to store:
promotion details for a plurality of promotions, and
a plurality of over-redemption-based promotion selection rules, wherein each of the plurality of rules is configured to select among the plurality of promotions based at least on an over-redemption score, and
a coupon generation module configured to:
access a consumer identifier in response to a received request for an electronic coupon,
access the consumer database to obtain an over-redemption score based on the accessed consumer identifier,
match a rule selected from the plurality of rules based on the obtained over-redemption score,
select a promotion based on the matched rule, and
encode a plurality of fields of data for inclusion in an electronic coupon for the selected promotion, wherein the plurality of fields of data comprise the unique consumer identifier and the unique coupon identifier.

9. The system of claim 8,
wherein the coupon generation module is configured to indirectly encode at least one of the plurality of fields for inclusion in the electronic coupon by, for each of the at least one of the plurality of fields of data:
associating the field of data with an identifier,
storing the field of data in a database in association with the identifier, and encoding the identifier directly into the electronic coupon; and
wherein the coupon decoding module is configured to obtain decoded coupon redemption data for a redeemed coupon by, for each of at least one of a plurality of indirectly encoded fields of data:
decoding an identifier from the coupon redemption data, and
using the decoded identifier to look up an indirectly encoded field of data in a database.

10. The system of claim 8, wherein the over-redemption score generation module is configured to calculate the coupon over-redemption score for a consumer by:
determining, for each of a plurality of coupons redeemed by the consumer in the coupon redemption history, a number of over-redemptions above an allowed number of redemptions for the coupon; and
summing the number of over-redemptions across the plurality of coupons.

11. The system of claim 10, wherein the over-redemption score generation module is configured to calculate the coupon over-redemption score for a consumer by further:
applying a logarithm to the summed number of over-redemptions across the plurality of coupons for a consumer to obtain a compressed score; and
normalizing the compressed score by scaling the compressed score in relation to a range of compressed scores for a plurality of consumers.

12. The system of claim 10, wherein the over-redemption score generation module is configured to calculate a coupon over-redemption score for a plurality of consumers by further assigning a percentile rank to each consumer in relation to others of the plurality of consumers based on a summed number of over-redemptions across a plurality of coupons for the consumer.

13. The system of claim 8, wherein the electronic coupons include coupons that are configured to be printed or displayed by the consumer devices, and for which coupons the coupon generation module encodes the plurality of fields of data into a barcode displayable on the coupon.

14. The system of claim 8, wherein the electronic coupons include coupons that are configured to include a human-readable code that can be entered or supplied by a consumer during an on-line or off-line purchase, and for which coupons the coupon generation module encodes the plurality of fields of data into the human-readable code.

15. A method comprising:
a coupon decoding module obtaining decoded coupon redemption data for a redeemed coupon by decoding received coupon redemption data, wherein the decoded coupon redemption data comprise a unique consumer identifier and a unique coupon identifier;
a consumer database storing:
a coupon redemption history comprising unique consumer identifiers stored in association with unique coupon identifiers, the coupon redemption history based on decoded coupon redemption data obtained from the coupon decoding module, and
unique consumer identifiers in association with coupon over-redemption scores;
an over-redemption score generation module calculating a coupon over-redemption score based on the coupon redemption history, wherein the coupon over-redemption score is indicative of a consumer's history of having redeemed unique coupons more than an allowed number of times
a promotion database storing:
promotion details for a plurality of promotions, and
a plurality of over-redemption-based promotion selection rules, wherein each of the plurality of rules is configured to select among the plurality of promotions based at least on an over-redemption score;
a coupon generation module accessing a consumer identifier in response to a request for an electronic coupon received from a consumer device,
the coupon generation module accessing the consumer database to obtain an over-redemption score based on the accessed consumer identifier,
the coupon generation module matching a rule selected from the plurality of rules based on the obtained over-redemption score,
the coupon generation module selecting a promotion based on the matched rule, and
the coupon generation module encoding a plurality of fields of data for inclusion in an electronic coupon for the selected promotion, wherein the plurality of fields of data comprise the unique consumer identifier and the unique coupon identifier.

16. The method of claim 15,
wherein the coupon generation module indirectly encodes at least one of the plurality of fields for inclusion in the electronic coupon by, for each of the at least one of the plurality of fields of data:
associating the field of data with an identifier,
storing the field of data in a database in association with the identifier, and
encoding the identifier directly into the electronic coupon; and
wherein the coupon decoding obtains decoded coupon redemption data for a redeemed coupon by, for each of at least one of a plurality of indirectly encoded fields of data:
decoding an identifier from the coupon redemption data, and
using the decoded identifier to look up an indirectly encoded field of data in a database.

17. The method of claim 15, wherein the over-redemption score generation module calculates the coupon over-redemption score for a consumer by:
determining, for each of a plurality of coupons redeemed by the consumer in the coupon redemption history, a number of over-redemptions above an allowed number of redemptions for the coupon; and
summing the number of over-redemptions across the plurality of coupons.

18. The method of claim 17, wherein the over-redemption score generation module calculates the coupon over-redemption score for a consumer by further:
applying a logarithm to the summed number of over-redemptions across the plurality of coupons for a consumer to obtain a compressed score; and
normalizing the compressed score by scaling the compressed score in relation to a range of compressed scores for a plurality of consumers.

19. The method of claim 17, wherein the over-redemption score generation module is configured to calculate a coupon over-redemption score for a plurality of consumers by further assigning a percentile rank to each consumer in relation to other consumers based on a summed number of over-redemptions across a plurality of coupons for the consumer.

20. The method of claim 15, wherein the electronic coupon is configured to be printed or displayed by the consumer device, and for which coupon the coupon generation module encodes the plurality of fields of data into a barcode displayable on the coupon.

21. The method of claim 15, wherein the electronic coupon includes a human-readable code that can be entered or supplied by a consumer during an on-line or off-line purchase, and for which coupon the coupon generation module encodes the plurality of fields of data into the human-readable code.
